(19) United States
(12) Patent Application Publication
(10) Pub. No.: US 2015/0190886 A1
(43) Pub. Date: Jul. 9, 2015

(54) Laser Processing Head with Resiliently Movable Shielding Sheets

(71) Applicant: TRUMPF LASER GMBH, Schramberg (DE)

(72) Inventor: Martin Huonker, Dietingen (DE)

(21) Appl. No.: 14/633,421

(22) Filed: Feb. 27, 2015

Related U.S. Application Data
(63) Continuation of application No. PCT/EP2013/065618, filed on Jul. 24, 2013.

(30) Foreign Application Priority Data
Aug. 27, 2012 (EP) 102012215147.8

(51) Int. Cl. B23K 26/30; B23K 26/14

(52) U.S. Cl. CPC B23K 26/427; B23K 26/1458

(57) ABSTRACT

A laser processing head for processing workpieces by a laser beam discharged from the laser processing head, comprising a shielding housing secured to the laser processing head for shielding the laser beam, the shielding housing being open at a workpiece side and being formed by a plurality of shielding sheets which are supported independently of each other so as to be resiliently movable relative to the laser processing head in a direction of the laser beam and a parallelogram bearing that secures the shielding sheets to a housing carrier of the shielding housing.

### CROSS-REFERENCE TO RELATED APPLICATION

This application is a continuation of and claims priority under 35 U.S.C. §120 to PCT Application No. PCT/EP2013/065618 filed on Jul. 24, 2013, which claimed priority to German Application No. DE 10 2012 215 147.8, filed on Aug. 27, 2012. The contents of both of these priority applications are hereby incorporated by reference in their entirety.

### TECHNICAL FIELD

The present invention relates to a laser processing head for processing workpieces by a laser beam, including a shielding housing which is secured to the laser processing head and which is open at the workpiece side for shielding the laser beam being discharged from the laser processing head.

### BACKGROUND

To shield the operating region in a safe manner with respect to a laser during laser processing operations, protective cabins or protective housings which surround the entire operating region of the laser processing machine (i.e., the complete component) are used. During operations on very large components, as occur, for example, in ship construction or steel construction, the shielding of the complete component is not economical; on the other hand for reasons of laser protection it is also not permissible to carry out laser welding operations without any shielding when persons are present in the vicinity of the laser beam.

A laser processing head of a generic type is disclosed, for example, in DE 20 2009 013 899 U1. The laser beam discharged from the laser processing head is shielded on a workpiece with respect to the environment by a plurality of circular brushes whose resiliently deformable bristles are in abutment with the workpiece in a non-light-permeable manner. For additional shielding of any gaps which may occur between the brushes, the laser processing head may further have at a remote outer side of the bristles a continuous closed cover or an integral covering housing.

DE 296 20 304 U1 further discloses a laser processing head which has a shielding unit in the form of an annular protective brush. The protective brush is arranged concentrically with respect to the laser beam and has a base to which resilient bristles are fitted as shielding elements. These bristles extend along the laser beam and shield the laser beam and the processing location radially outwards with respect to the environment. The protective brush is resiliently suspended on the processing head to follow the surface structure of a workpiece.

Finally, DE 10 2010 005 043 A1 discloses a welding device having a shielding device which is constructed as an integral housing wall which surrounds the laser beam. The welding device has a suction device which is connected in a communicating manner to the shielding device and which evacuates the region of the weld location during the welding operation.

### SUMMARY

Certain aspects of the invention relate to a laser processing head configured in a manner such that during the laser processing operation, a shielding housing is prevented from being lifted from the processed workpiece in a reliable manner.

In some embodiments, the shielding housing is formed by a plurality of shielding sheets which are supported independently of each other so as to be resiliently movable in each case relative to the laser processing head in the direction of the laser beam being discharged from the laser processing head, and the shielding sheets are each secured to a housing carrier of the shielding housing by a parallelogram bearing.

The individual shielding sheets, when the laser processing head is placed with the shielding housing thereof on a workpiece to be processed, can be displaced by the workpiece counter to a resilient restoring force in the direction towards the laser processing head and are in abutment with corresponding resilient pressure with the workpiece. When the laser processing head is moved, the shielding sheets then slide in a resilient manner over the surface of the workpiece, without being lifted from the workpiece. The laser processing head is particularly suitable for use with comparatively large components with long, preferably linear I-seams (as often occur, for example, in ship construction).

The shielding sheets can be displaceably guided in any known manner counter to the effect of a resilient restoring force. In a particularly structurally simple manner, the shielding sheets are secured in a resiliently movable manner to a housing carrier, by parallelogram bearings, for example, in the form of two parallel resilient sheets.

In the shielding sheets at the workpiece side, resilient sealing elements preferably protrude beyond the sheet edge by a few millimeters and consequently constitute the actual abutment of the shielding sheets against the workpiece. These sealing elements are provided to seal the shielding sheets with respect to the workpiece to be processed in a non-light-permeable manner and may, for example, be constructed as non-light-permeable brushes or protective cloths of laser-resistant and laser-absorbent material.

In some embodiments, the shielding housing has at least one side opening which is open with respect to the environment and via which gases and also smoke can be discharged from the shielding housing outwards into the environment during the processing.

The at least one side opening can be formed by a gap between two adjacent shielding sheets of the shielding housing, which gap may be covered by an edge portion of one of the two adjacent shielding sheets. The edge portion prevents laser radiation from being discharged outwards from the inner side of the shielding housing.

The at least one side opening can be formed by one or more holes which are provided in the shielding housing (for example, in the form of a pattern or grid of holes) and which may be covered by a cover which is arranged with spacing in front of and/or behind it/them. For example, a large number of holes which are arranged in a sieve-like pattern may be constructed as side openings in one or more housing walls of the shielding housing. The cover prevents laser radiation from being discharged outwards from the inner side of the shielding housing. To this end, the cover is typically formed from a laser-resistant and laser-absorbent material or coated with such a material at the side facing the laser beam.

At least one cross jet nozzle can be arranged in the shielding housing to produce a transverse flow which extends through the laser beam and which protects an optical processing system of the laser processing head from splashes of material which occur during the workpiece processing operation, and/or a suction opening for evacuation of gases and smoke which are inside the shielding housing. To maintain a reduced pressure in the shielding housing in spite of the air which is introduced via the cross jet nozzle, the suction of the suction device is intended to be adjusted to be greater than the introduction of the cross jet nozzle.

Other advantages of the invention will be appreciated from the claims, the description and the drawings. The features mentioned above and those set out below may also be used individually per se or together in any combination. The embodiments shown and described are not intended to be understood to be a conclusive listing but are instead of exemplary character for describing the invention.

### DESCRIPTION OF DRAWINGS

FIG. 1 is a perspective view of a laser processing head with a shielding housing which is formed by four resiliently movable shielding sheets without a shielding cover.

FIG. 2 is another perspective view of the laser processing head from FIG. 1 with only two shielding sheets which face each other.

FIG. 3 is another perspective view of the shielding housing from FIG. 1.

FIG. 4 shows the laser processing head from FIG. 1 with a shielding cover.

FIG. 5 is a perspective view of another laser processing head with a plurality of air openings which are provided in the shielding housing.

### DETAILED DESCRIPTION

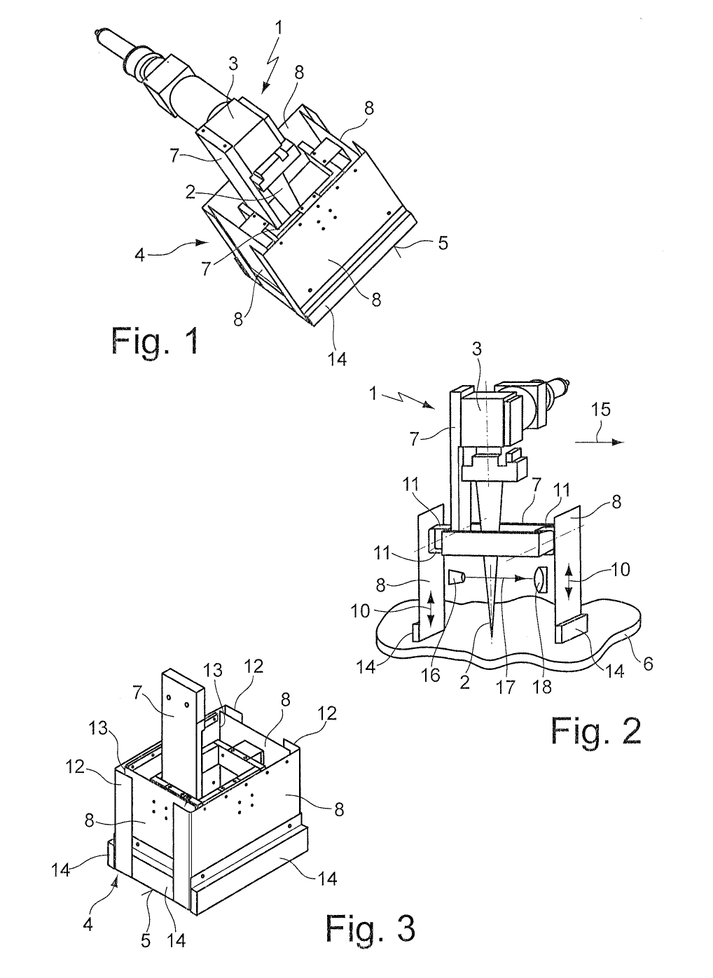

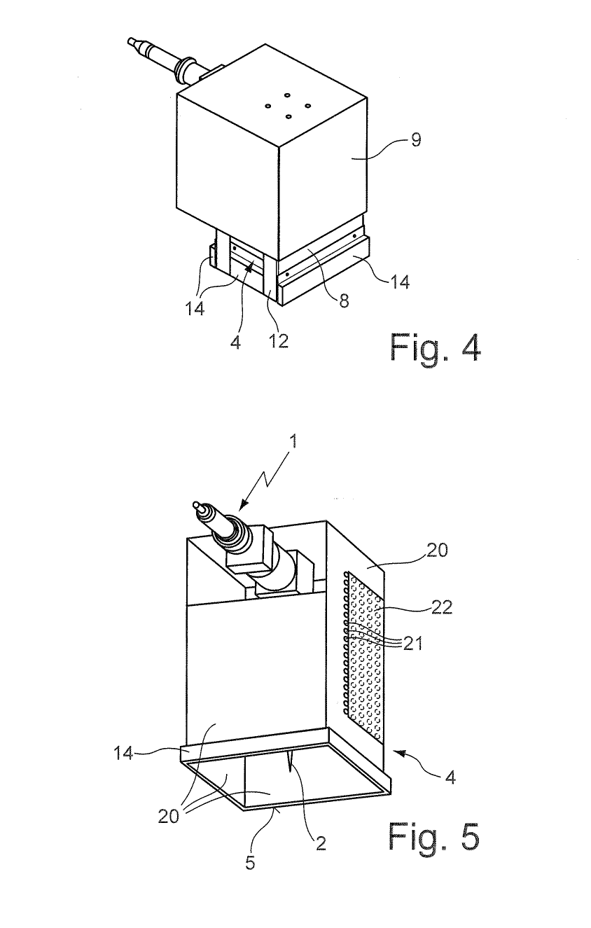

The laser processing head 1 shown in FIGS. 1 to 5 serves to process workpieces by a focused laser beam 2 which is discharged from the laser processing head 1 via processing optics 3. To shield the laser beam 2 being discharged from the laser processing head 1 secured to the laser processing head 1 is a shielding housing 4 which is open at the workpiece side and which is arranged around the laser beam 2. During the laser processing operation shielding housing 4 is placed with the open housing side 5 thereof on the workpiece 6 to be processed. The shielding housing 4 shields the laser radiation locally at the location of the occurrence—directly on the laser processing head 1 or at the interaction zone—and is particularly intended for use on large components with long, preferably linear seams (e.g., as occur in ship construction).

The shielding housing 4 shown in FIGS. 1 to 4 is formed by a frame-like housing carrier 7 which is securely connected to the laser processing head 1 and four individual shielding sheets 8 which are arranged at right angles with respect to each other. A shielding hood 9 which is secured, for example, to the housing carrier 7, completely covers the laser processing head 1 and substantially covers the shielding housing 4.

The shielding sheets 8 are supported in a resiliently movable manner on the housing carrier 7 independently of each other in the direction of the laser beam 2 being discharged from the laser processing head 1, as shown in FIG. 2 by double-headed arrows 10. A resiliently movable support may, for example, be constructed as a fixed parallelogram bearing in the form of two parallel resilient sheets 11 of thin resilient sheet metal which may each be formed as individual strips or, as in this instance, together from a resilient sheet metal strip which is folded twice. As shown in FIG. 2, these folded resilient sheet metal strips are each secured to the housing carrier 7 with the two folded free ends thereof and secured at the inner side to the shielding sheet 8 with the center portion thereof (for example, by rivets). The fixed parallelogram bearing enables a relative displacement of the shielding sheet 8 in the direction 10 counter to the restoring force of the two resilient sheets 11. As an alternative to the fixed parallelogram bearing, the shielding sheets 8 may also be displaceably guided in a linear manner on the housing carrier 7 counter to the action of a restoring spring.

The four shielding sheets 8 are arranged in a rectangle, two mutually opposing shielding sheets 8 being constructed in an identical manner in each case. Two mutually opposing shielding sheets 8 are folded or bent at the side edges thereof with these folded edge portions 12 to engage over the side edge of the adjacent shielding sheets 8 with spacing or to overlap it with spacing. Between adjacent shielding sheets 8 there is provided in each case a gap 13 which is covered in an outward direction by the bent edge portion 12. The gap 13 forms an opening which is open with respect to the environment and through which air from the environment can flow into the inner side of the shielding housing 4 or gases and smoke can flow from the inner side of the shielding housing 4 outwards into the environment. As a result of the partial overlapping of adjacent shielding sheets 8 in the corner regions of the shielding housing 4, no laser radiation can be discharged via the gaps 13 outwards from the inner side of the shielding housing 4. For non-light-permeable sealing with respect to the workpiece 6, the shielding sheets 8 may have in each case at the workpiece-side end thereof sealing elements 14, for example, in the form of resilient protective brushes or protective cloths of laser-resistant and laser-absorbent material which protrude by a few millimeters beyond the shielding sheets 8 and consequently constitute the actual abutment of the shielding sheets 8 against the workpiece 6.

When the laser processing head 1 is in the desired position above the workpiece 6, the shielding sheets 8 are displaced by the workpiece 6 counter to the restoring force of the resilient sheets 11 in the direction towards the laser processing head 1 and are in abutment with the sealing elements 14 thereof with corresponding resilient pressure against the workpiece 6. When the laser processing head 1 is moved in the feed direction 15, the shielding sheets 8 then slide with the sealing elements 14 thereof over the surface of the workpiece 6 in a resilient manner.

The workpiece-side edges of the shielding sheets 8 or the sealing elements 14 are constructed in a linear manner for placement on a planar workpiece surface and are consequently particularly suitable for welding butt joints (I-seams). For placement on angular or round workpiece surfaces, the shielding sheets 8 accordingly can have contoured workpiece-side edges, that is to say, in the case of overlapping or T-joints (fillet welds), shielding sheets with triangular ends.

There is advantageously arranged within the shielding housing 4 a cross jet nozzle 16 for producing a transverse air flow 17 which extends parallel to the workpiece 6 in front of the processing optics 3 and which extends through the laser beam 2 to protect the processing optics 3 from material splashes which occur during the laser processing operation. To evacuate the transverse air flow 17 and/or gases and smoke, a suction opening 18 of a suction device (not shown) is arranged on or in the shielding housing 4. As shown in FIG. 2, the cross jet nozzle 16 and the suction opening 18 in the shielding housing 4 are preferably arranged at substantially the same height and so as to face each other. To maintain a reduced pressure in the shielding housing 4 in spite of the air which is supplied via the cross jet nozzle 16, the suction of the suction device is intended to be adjusted to be greater than the flow of the cross jet nozzle.

FIG. 5 shows another laser processing head 1 with a shielding housing 4 which is secured thereto in a non-displaceable manner and which is open at the workpiece side. The shielding housing 4 is constructed in an integral manner but may also be composed of individual shielding sheets. As shown by way of example on one of the four housing walls 20, one or more housing walls 20 has/have a large number of openings (holes) 21 which are open with respect to the environment and through which air can flow from the environment into the inner side of the shielding housing 4 or gases and smoke can flow outwards from the inner side of the shielding housing 4 into the environment. For non-light-permeable sealing with respect to the workpiece 6, the shielding housing 4 may have at the workpiece-side end thereof a sealing element 14 which extends all the way around, for example, in the form of resilient protective brushes or protective cloths of laser-resistant and laser-absorbent material.

In the case of a cross jet nozzle which is provided inside the shielding housing 4, the holes 21 may be provided in particular in the housing wall facing the cross jet nozzle. In the case of a suction opening for a suction device (not shown) arranged in or on the shielding housing 4, sufficient air can flow via the openings 21 from the environment into the shielding housing 4 when the suction device is activated. By a cover (for example, covering sheet) 22 which is fitted at the outer side (and/or inner side) with spacing in front of the openings 21, no laser radiation can be discharged via the openings 21 from the inner side of the shielding housing 4 to the outer side. The cover 22 is, for example, formed by a laser-resistant material or coated with a laser-resistant material at the inner side thereof facing the laser beam 2.

At the locations at which the shielding housing 4 protrudes beyond a robot arm of the laser processing head 1 and cables/lines lead into the shielding housing 1, flexible elements of laser protection curtain material may further be provided to better seal gaps which are unavoidable at this location.

A number of embodiments of the invention have been described. Nevertheless, it will be understood that various modifications may be made without departing from the spirit and scope of the invention. Accordingly, other embodiments are within the scope of the following claims.

What is claimed is:

1. A laser processing head for processing workpieces by a laser beam discharged from the laser processing head, comprising:
a shielding housing secured to the laser processing head for shielding the laser beam, the shielding housing being open at a workpiece side and being formed by a plurality of shielding sheets which are supported independently of each other so as to be resiliently movable relative to the laser processing head in a direction of the laser beam; and
a parallelogram bearing that secures the shielding sheets to a housing carrier of the shielding housing.

2. The laser processing head according to claim 1, wherein the parallelogram bearing is formed by two parallel resilient sheets.

3. The laser processing head according to claim 1, wherein the shielding housing is formed by four shielding sheets which are arranged in a rectangle.

4. The laser processing head according to claim 1, wherein non-light-permeable sealing elements protrude from the shielding sheets at the workpiece side.

5. The laser processing head according to claim 1, wherein the shielding housing has at least one side opening which is open to the environment.

6. The laser processing head according to claim 5, wherein the at least one side opening is formed by a gap between two adjacent shielding sheets of the shielding housing.

7. The laser processing head according to claim 6, wherein the gap is covered by an edge portion of one of the two adjacent shielding sheets.

8. The laser processing head according to claim 5, wherein the at least one side opening is formed by one or more holes which are provided in the shielding housing.

9. The laser processing head according to claim 8, wherein the one or more holes are covered by a cover which is arranged with spacing in front of or behind the one or more holes.

10. The laser processing head according to claim 8, wherein the one or more holes are covered by a cover which is arranged with spacing in front of and behind the one or more holes.

11. The laser processing head according to claim 1, wherein at least one cross jet nozzle is arranged in the shielding housing to produce a transverse flow which protects the laser processing head.

12. The laser processing head according to claim 11, wherein the cross jet nozzle and a suction opening are arranged in or on the shielding housing.

13. The laser processing head according to claim 12, wherein the cross jet nozzle and the suction opening face each other.

14. The laser processing head according to claim 12, wherein the cross jet nozzle and the suction opening face each other at the same height.

15. The laser processing head according to claim 1, wherein a suction opening is arranged in or on the shielding housing.
